(19) United States
(12) Patent Application Publication
(10) Pub. No.: US 2003/0003881 A1
(43) Pub. Date: Jan. 2, 2003

(54) Antenna connection and switching for transmit and receive diversity

(76) Inventors: Kofi Dankwa Anim-Appiah, Allen, TX (US); Anuj Batra, Dallas, TX (US)

Correspondence Address: J. Dennis Moore, Texas Instruments Incorporated, M/S 3999, P. O. Box 655474, Dallas, TX, 75265, US

(21) Appl. No.: 10/081,391

(22) Filed: Feb. 22, 2002

Related U.S. Application Data
(60) Provisional application No. 60/301,402, filed on Jun. 27, 2001.
(60) Provisional application No. 60/344,896, filed on Dec. 31, 2001.

(51) Int. Cl. H04B 1/02

(52) U.S. Cl. 455/101; 455/103; 455/83

(57) ABSTRACT

By using switches (110) that are synchronously controlled, the present invention permits connection of a plurality of antennae (130) to a plurality of radio front end units (radios 120) so that at any time any of the radios (120) may be assigned to any of the antennae (130) without leaving any radio (120) unconnected. A controller (140) arbitrarily assigns, at any time, any of the radios (120) to any of the antennae (130) while keeping every radio (120) connected to an antenna (130).

This application claims the priority under 35 U.S.C. §119(e)(1) of copending U.S. provisional application No. 60/301,402, filed on Jun. 27, 2001 and copending U.S. provisional application No. 60/344,896, filed on Dec. 31, 2001. The aforementioned patent applications are incorporated herein by reference.

### FIELD OF THE INVENTION

The invention relates generally to wireless communication systems and, more particularly, to an antenna to radio connection and switching for transit and receive diversity.

### BACKGROUND OF THE INVENTION

Transmission properties, such as gain and phase, of wireless communication channels are time-varying statistical quantities. Therefore, in a wireless communication system characterized by one (1) transmit antenna and one (1) receive antenna, transmission of information can be unreliable because the wireless channel that exists between the two (2) antennae is constantly changing. In digital wireless systems, the degrading effects of statistical channel variations are particularly evident and are manifested as packet errors. This degradation occurs whether or not there is relative movement between the transmit antenna and the receive antenna because it is still possible for the environment to change. Wireless channels are also rendered unreliable because the signal at the receive antenna is the superposition of many waves that travel paths of different lengths to the receive antenna and add constructively or destructively. When the waves add destructively, deep fades are experienced. When these fades occur, it is difficult to equalize the channel and decode the data correctly.

One of the most effective ways to overcome this degradation in channel reliability is by employing receive diversity (the deployment of multiple receive antennae). In many scenarios, when the receive antennae are spatially separated by more than half a wavelength, the different receive signals are essentially uncorrelated and independent of the other received signals. Therefore, at an instant in time when the signal-to-noise ratio (SNR) at the output of one antenna is low, there is a good chance that the SNR at the output of at least one of the other antennae is high.

There are several well-known diversity reception techniques that either combine the signals from multiple antennae in different ways or periodically sample the signal from each of the receive antennae and then connect the antenna with the strongest signal to the receiver. It has recently been shown that the benefits of diversity reception can also be obtained from diversity transmission, where multiple transmit antennae simultaneously send differently-encoded versions of the same information. Multiple radios are required to employ diversity transmission. The general case for diversity would then consist of T transmit antennae and R receive antennae.

When N different radios must share N antennae, diversity transmission and/or reception becomes more difficult to implement. This case may be encountered when, for example, N independent wireless communication systems, each using a different modulation scheme (therefore requiring separate radios), must share N common receive antennae due to limitations such as space constraints. For the implementation of receive diversity, it is problematical to determine how to connect the antennae to the radios so that at any time any of the radios may be assigned to any of the antennae without leaving any radio unconnected. An identical problem arises for the implementation of transmit diversity when several communication systems share N common transmit antennae and at least one of the systems implements M-transmit diversity (M<N), If, for example, exactly one (1) system implements M-transmit diversity, then a total of N−M+1 simultaneous transmit systems can be supported by N transmit antennae. Periodically, for a finite length of time, the system implementing M-transmit diversity will require that its M radios be simultaneously connected to M antennae. A problem also exists in determining the radio-antennae connection configuration if the M radio-antennae connections are required to be mutable.

It is therefore desirable to provide a solution that permits connection of a plurality of antennae to a plurality of radios (radio front end units) so that at any time any of the radios may be assigned to any of the antennae without leaving any radio unconnected. The present invention provides this through synchronously controlled switches that enable a controller to arbitrarily assign any of the radios to any of the antennae while keeping every radio connected to an antenna.

### BRIEF DESCRIPTION OF THE DRAWINGS

The above and further advantages of the invention may be better understood by referring to the following description in conjunction with the accompanying drawings in which corresponding numerals in the different figures refer to the corresponding parts, in which:

FIG. 1 illustrates an N-radio-to-N-antenna switching arrangement with 2N switches in accordance with an exemplary embodiment of the present invention;

FIG. 2 shows a table of simultaneous connections made by FIG. 1;

FIG. 3 illustrates a 2-radio-to-2-antenna switching arrangement with four (4) single-pole-double-throw switches in accordance with an exemplary embodiment of the present invention;

FIG. 4 illustrates a 2-radio-to-2-antenna switching arrangement with four (4) single-pole-double-throw switches in accordance with a further exemplary embodiment of the present invention;

FIG. 5 illustrates a 3-radio-to-3-antenna switching arrangement with six (6) single-pole-triple-throw switches in accordance with an exemplary embodiment of the present invention;

FIG. 6 illustrates a 3-radio-to-3-antenna switching arrangement with six (6) single-pole-triple-throw switches in accordance with a further exemplary embodiment of the present invention;

FIG. 7 shows a table of simultaneous connections made by FIG. 6;

FIG. 8 illustrates an N-radio-to-N-antenna switching arrangement with N switches in accordance with an exemplary embodiment of the present invention;

FIGS. 9A and 9B illustrate N-radio-to-N-antenna switching arrangements with N single-pole-N-throw switches for N=2 and N=3, respectively, in accordance with exemplary embodiments of the present invention; and

FIGS. 10A and 10B illustrate single-pole-N-throw switches constructed from single-pole-double-throw switches for N=3 and N=4, respectively, in accordance with exemplary embodiments of the present invention.

### DETAILED DESCRIPTION

While the making and using of various embodiments of the present invention are discussed herein in terms of specific switches and switch configurations, it should be appreciated that the present invention provides many inventive concepts that can be embodied in a wide variety of contexts. The specific embodiments discussed herein are merely illustrative of specific ways to make and use the invention, and are not meant to limit the scope of the invention.

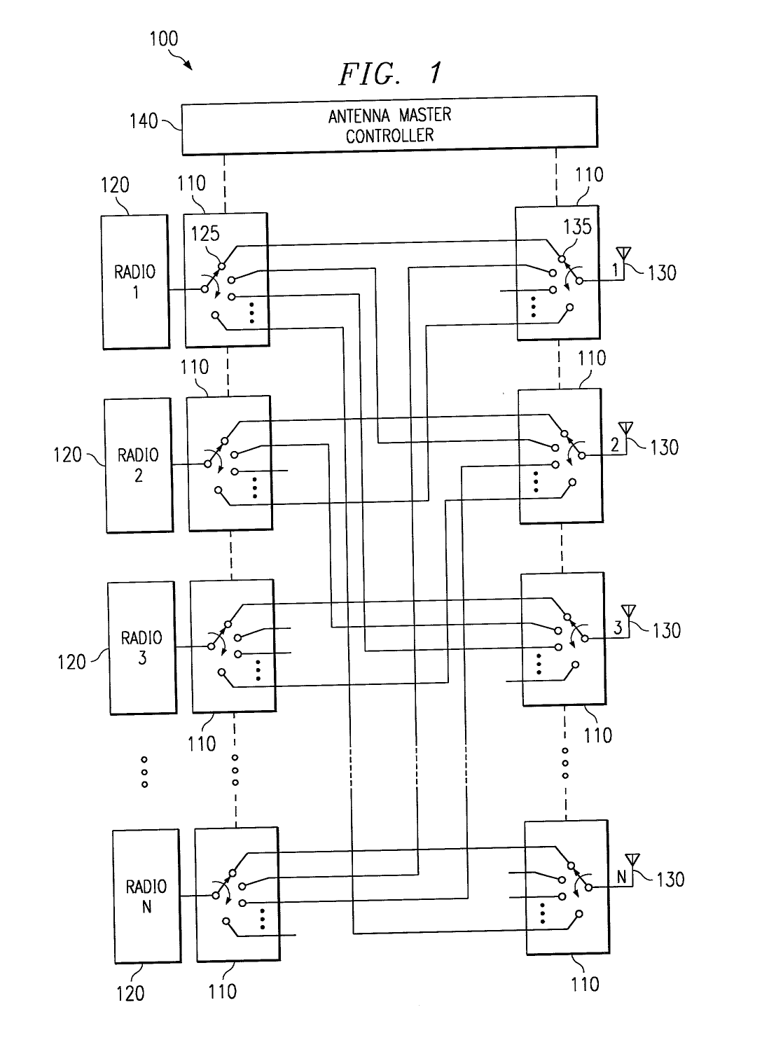

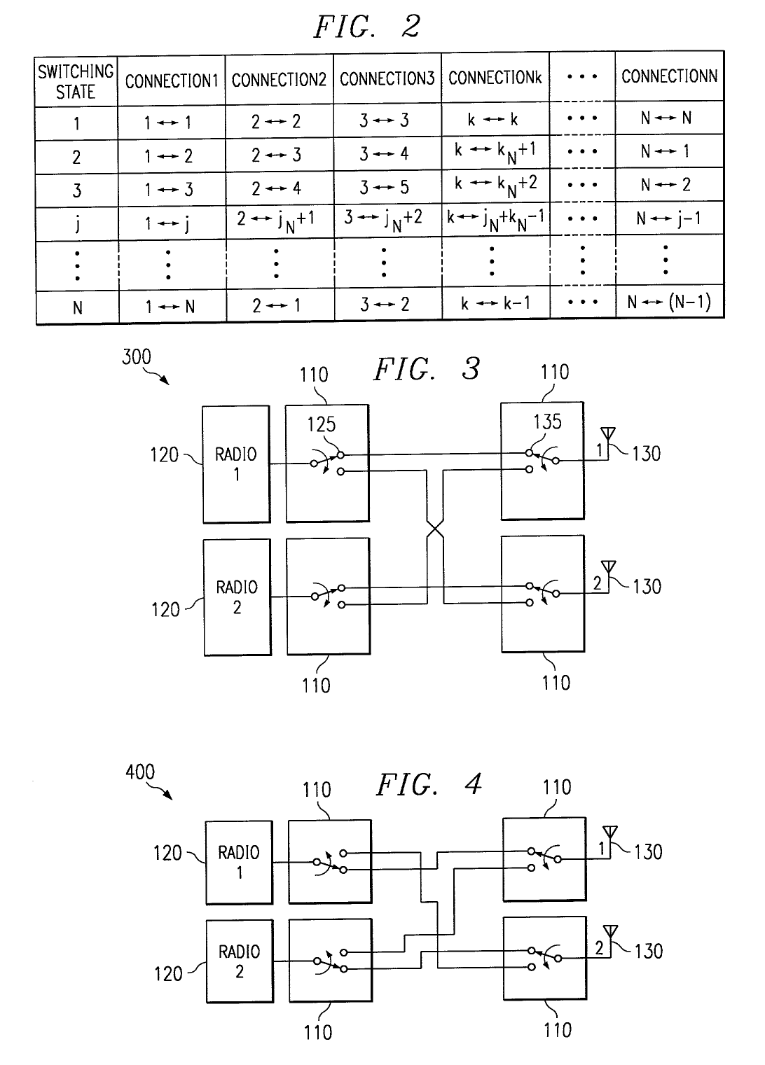

FIG. 1 illustrates N radio 120 to N antenna 130 switching arrangement 100 with 2N switches 110 in accordance with an exemplary embodiment of the present invention. The arrangement of FIG. 1 (and also FIGS. 2-10B, below) can be implemented as a wireless transmitter system, a wireless receiver system, or a wireless transceiver system, such as an IEEE 802.11 system, a Bluetooth system or a Global System for Mobile Communication (GSM). Switching arrangement 100 does not use power splitters, each of which carries a 3 dB reduction in power delivered to a radio 120 or an antenna 130. Therefore, switching arrangement 100 minimizes radio frequency (RF) power losses due to the connection and switching. FIG. 1 uses exactly 2N synchronously controlled single-pole-N-throw (SPNT) switches 110. Each SPNT switch 110 is connected to a radio (a radio front end unit) 120 and has N outgoing contacts 125 that allow connection to N distinct antennae 130. Likewise, each SPNT switch 110 connected to an antenna 130 has N incoming contacts 135 that allow connection to N distinct radios 120. Since there are exactly (N!)^{2N} possible ways to connect 2N SPNT switches 110, by synchronously switching switches 110 through N possible states, each radio 120 can be connected to each antenna 130. FIG. 2 shows a table of simultaneous connections made by simultaneously switching switches 110, wherein x_{N}≡x mod N. Left-hand-side numerals are the radio indices; right-hand-side numerals are the antenna indices. The wiring shown in FIG. 1 makes the connections according to FIG. 2, but there are many other wiring configurations that also implement these connections.

In switching arrangement 100, there are always exactly two (2) switches 110 between a radio 120 and the antenna 130 to which it is connected. Since each switch 110 has an associated insertion loss, switching arrangement 100 minimizes the number of switches 110 in the path between a radio 120 and the antenna 130 to which it is connected. Switching arrangement 100 also avoids leaving any radio 120 or antenna 130 unconnected or unterminated. Control of the switching can reside with a single antenna master controller 140 which could be a microprocessor that controls switches 110 to make the desired radio 120 to antenna 130 connections. Antenna master controller 140 can assign any antenna 130 to a particular radio 120, and then simultaneously assign the remaining radios 120 to respective ones of the remaining antennae 130 depending on which of the (N!)^{2N} wiring configurations is implemented and which radio 120 to antenna 130 assignment has already been made by the antenna master.

For any one of the N switching states of FIG. 2, all switches 110 of FIG. 1 are in the same position, and each of the N switching states dictates a different (common) position for switches 110. That is, switching state 1 requires all switches 110 to be in position 1, switching state 2 requires all switches 110 to be in position 2, etc., where position 1 corresponds to the top contact of the switch, position 2 corresponds to the contact immediately below the top contact, etc. This makes it particularly easy to control switches 110 since each switch 110 is controlled to the same position at any given time. For N=2, there are sixteen (16) possible ways to wire the four (4) SP2T switches 110. One way, consistent with FIGS. 1 and 2, is shown in FIG. 3 which illustrates two-radio 120 to two-antenna 130 switching arrangement 300 with four (4) single-pole-double-throw switches 110 in accordance with an exemplary embodiment of the present invention. Each SP2T switch 110 is connected to a radio 120 and has two (2) outgoing contacts 125 that allow connection to two (2) distinct antennae 130. Likewise, each SP2T switch 110 connected to an antenna 130 has two (2) incoming contacts 135. Switches 110 are shown in one of two (2) possible switching states, that which implements the first row (switching state 1) of FIG. 2. The other possible switching state implements the last row (switching state N, for N=2) of FIG. 2.

Another way to connect switches 110 for N=2 is shown in FIG. 4 which illustrates two-radio 120 to two-antenna 130 switching arrangement 400 with four (4) single-pole-double-throw switches 110 in accordance with an exemplary embodiment of the present invention. This configuration also implements FIG. 2, but the set of states of individual switches 110 which makes a specific radio 120 to antenna 130 connection is different from that of FIG. 3. Specifically, the four (4) switches 110 are never all in the same position for either of the two (2) possible switching states (i.e., radio1 [symbol] antenna1 and radio2 [symbol] antenna2 or radio1 [symbol] antenna2 and radio2 [symbol] antenna1). Therefore, in this configuration, switches 110 cannot all be driven by the same control signal unless the default state of switches 110 are different.

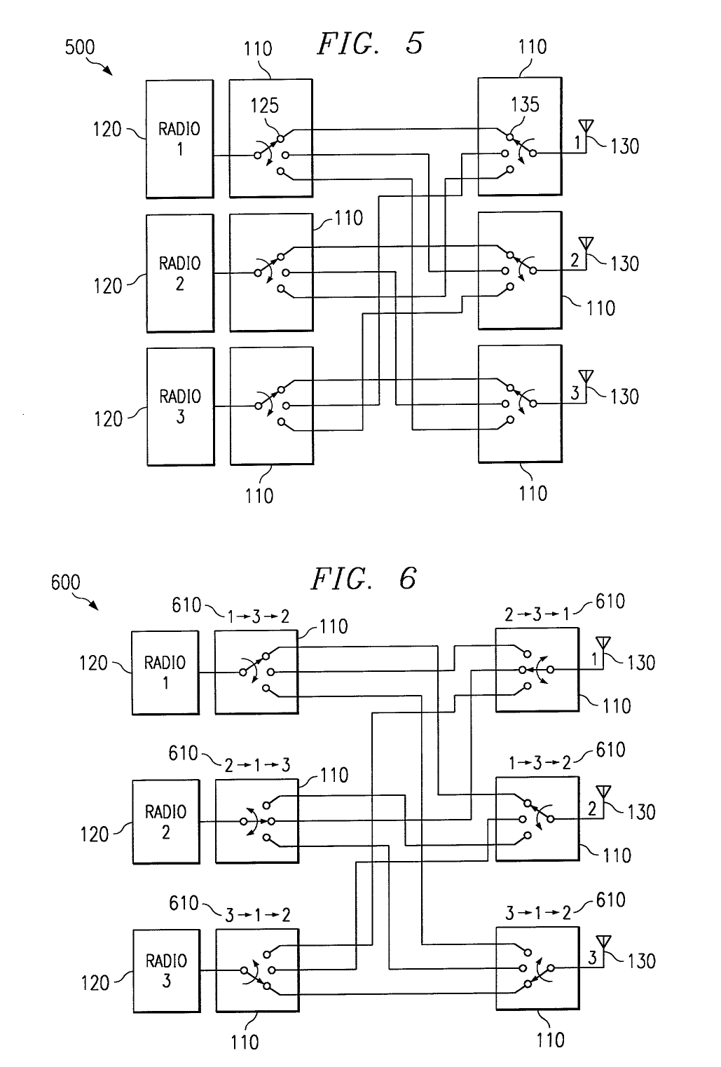

For N=3, there are 46,656 possible ways to wire the six (6) SP3T switches. One way, consistent with FIGS. 1 and 2, is shown in FIG. 5 which illustrates three-radio 120 to three-antenna 130 switching arrangement 500 with six (6) single-pole-triple-throw switches 110 in accordance with an exemplary embodiment of the present invention. Each SP3T switch 110 is connected to a radio 120 and has three (3) outgoing contacts 125 that allow connection to three (3) distinct antennae 130. Likewise, each SP3T switch 110 connected to an antenna 130 has three (3) incoming contacts 135. Switches 110 are shown in one of three (3) possible switching states, that which implements the first row of FIG. 2. The other two (2) possible switching states implement the last two (2) rows, respectively, of FIG. 2 (for N=3 and j=2).

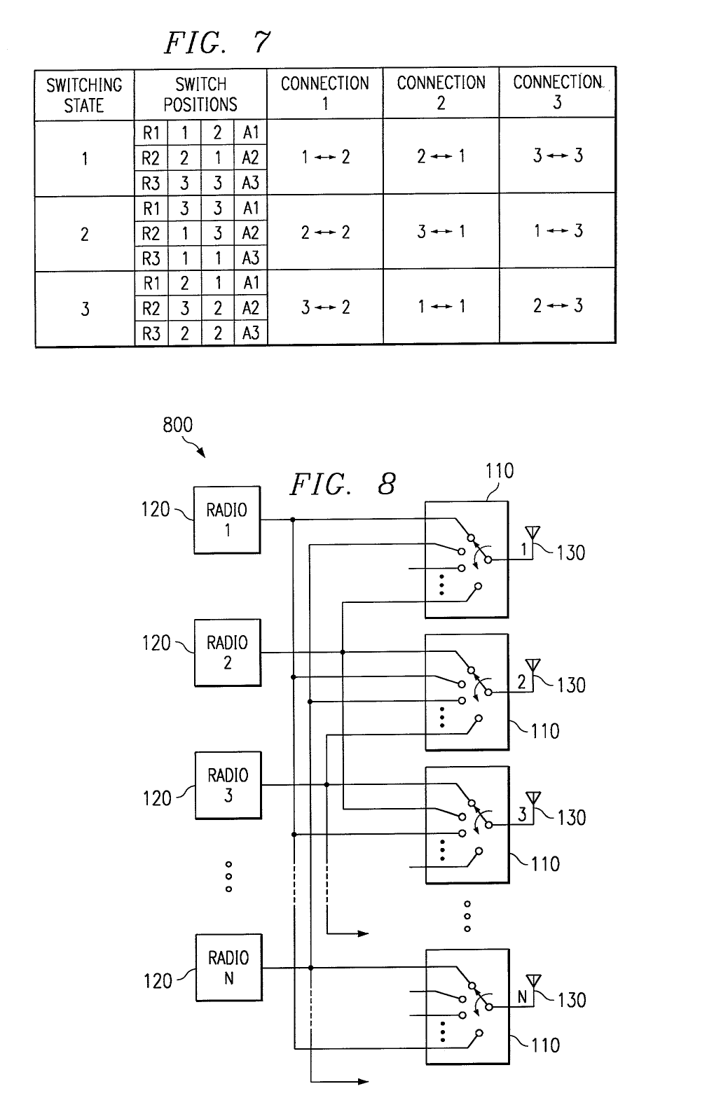

Another way to connect switches 110 for N=3 is shown in FIG. 6 which illustrates three-radio 120 to three-antenna 130 switching arrangement 600 with six (6) single-pole-triple-throw switches 110 in accordance with an exemplary embodiment of the present invention. For this case, the set of switching states is different from those listed in FIG. 2 and is given, instead, by FIG. 7. It can be seen from FIG. 7 that, for the wiring connections depicted in FIG. 6, any radio 120 can still be assigned to any antenna 130. Number sequence 610 shown above each switch 110 gives the sequence of positions (where 1 represents the top contact, 2 represents the middle contact and 3 represents the bottom contact) through which that particular switch 110 must progress in order to implement the connections in FIG. 7. It can thus be observed from FIG. 6 that individual SP3T switches 110 are never all in the same state and therefore cannot be driven by the same control signal. As is the case for FIG. 1, switching arrangement 600 allows all switches 110 to change positions at the same time. Sequences 610 of FIG. 6 can also be seen in FIG. 7 wherein, for each of the three (3) switching states, the switch positions of switches 110 associated with radio1 (R1), radio2 (R2), radio3 (R3), antenna1 (A1), antenna2 (A2) and antenna3 (A3) are shown in the “Switch Positions” column adjacent to the corresponding reference symbol R1, R2, R3, A1, A2 and A3.

Although FIG. 1 shows discrete SPNT switches 110, pairs, triplets, quartets, etc. of these SPNT switches 110 could be combined (for example, in parallel) into 2PNT, 3PNT, 4PNT, etc. switches 110, respectively, with MPNT representing an “M pole N throw” switch 110. This would yield an implementation that uses fewer, but more complex, switches 110.

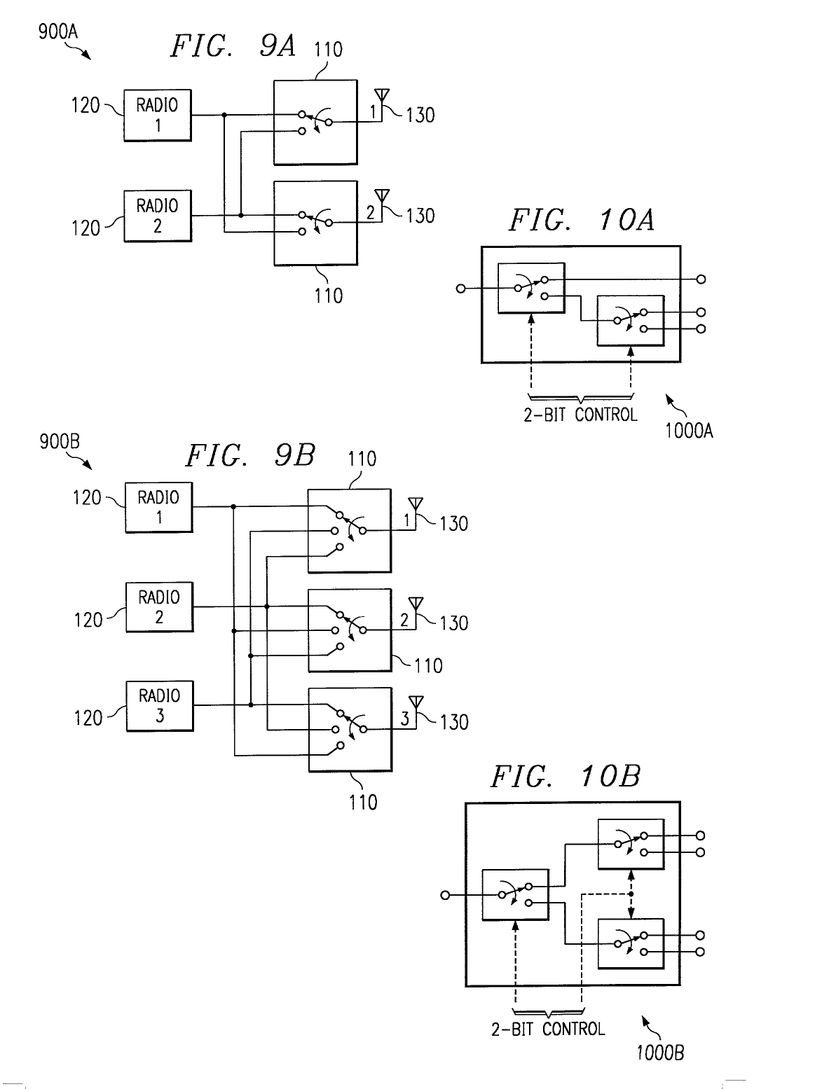

For the case where the switching circuit is fabricated as stripline or microstrip, and power splitters or power dividers are not used, it is possible to accomplish the general diversity switching arrangement with only N SPNT switches 110 as shown in FIG. 8 which illustrates N radio 120 to N antenna 130 switching arrangement 800 with N switches 110 in accordance with an exemplary embodiment of the present invention. In this configuration, there is only one switch 110 in the path between a radio 120 and an antenna 130. Reflective losses from the N−1 possibly unterminated stubs at each radio 120 connection can be minimized if stub lengths are kept very short compared to the wavelength of the RF carrier. The N radios 120 can be wired to the N switches 110 in (N!)^{N} ways. FIGS. 9A and 9B illustrate N radio 120 to N antenna 130 switching arrangements 900A and 900B, respectively, with N single-pole-N-throw switches 110 for N=2 and N=3, respectively, in accordance with exemplary embodiments of the present invention. The configurations shown in FIGS. 9A and 9B implement the connections in FIG. 2.

The SPNT switches 110 used in switching arrangement 100 can also be implemented as configurations of SP2T switches. The motivation for this is that SP2T switches are very common and allow simple binary control. It can be shown by mathematical induction that an SPNT switch can always be constructed from N−1 SP2T switches. It can also be shown that N−1 is the minimum number of SP2T switches required to construct an SPNT switch. FIGS. 10A and 10B illustrate single-pole-N-throw switches 1000A and 1000B, respectively, constructed from single-pole-double-throw switches for N=3 and N=4, respectively, in accordance with exemplary embodiments of the present invention. However, with SPNT switches constructed from the minimum number of SP2T switches, the number of switch contacts in the path between the SPNT input and one of its N outputs is variable. Therefore, the insertion loss will change according to the particular connection made in the SPNT switch. For example, there is a minimum of one (1) and a maximum of two (2) SP2T switch contacts in a path in SP3T switch 1000A, while for SP4T switch 1000B, there are always exactly two (2) SP2T switch contacts in each path. The minimum and maximum number of switch contacts in these SPNT constructions can be easily computed recursively.

Although exemplary embodiments of the present invention have been described in detail, it will be understood by those skilled in the art that various modifications can be made therein without departing from the spirit and scope of the invention as set forth in the appended claims.

What is claimed is:

1. A wireless communication system, comprising:
a number, N, of wireless front end units;
a number, N, of antennae; and
a switching arrangement connected between the N wireless front end units and the N antennae for permitting any of the wireless front end units to be switched into connection with any of the antennae while also maintaining the remaining wireless front end units connected to respective ones of the remaining antennae.

2. The wireless communication system of claim 1 wherein said switching arrangement includes N switches.

3. The wireless communication system of claim 2 wherein said switching arrangement includes a controller coupled to the N switches for synchronously controlling the N switches.

4. The wireless communication system of claim 3 wherein said controller is for switching the N switches simultaneously.

5. The wireless communication system of claim 3 wherein said controller synchronously controls the N switches using a single control signal.

6. The wireless communication system of claim 2 wherein each of the N switches is a single-pole switch.

7. The wireless communication system of claim 2 wherein each of the N switches further includes N contacts.

8. The wireless communication system of claim 2 wherein each of the N switches is an N-throw switch.

9. The wireless communication system of claim 2 wherein the N switches are respectively coupled to the N antennae.

10. The wireless communication system of claim 9 wherein the N switches are each coupled to all of said wireless front end units.

11. The wireless communication system of claim 9 wherein each wireless front end unit is coupled to all of the N switches.

12. The wireless communication system of claim 2 wherein each of the N switches comprises at least one single-pole-double-throw switch.

13. The wireless communication system of claim 1 wherein said switching arrangement includes 2N switches.

14. The wireless communication system of claim 13 wherein said switching arrangement includes a controller coupled to the 2N switches for synchronously controlling the 2N switches.

15. The wireless communication system of claim 14 wherein said controller is for switching the 2N switches simultaneously.

16. The wireless communication system of claim 14 wherein said controller synchronously controls the N switches using a single control signal.

17. The wireless communication system of claim 13 wherein each of the 2N switches is a single-pole switch.

18. The wireless communication system of claim 13 wherein each of the 2N switches further includes N contacts.

19. The wireless communication system of claim 13 wherein each of the 2N switches further comprises at least one single-pole-double-throw switch.

20. The wireless communication system of claim 13 wherein a first N of the switches are respectively coupled to the N antennae, a further N of the switches are respectively coupled to the N wireless front end units, and each of the first N switches are coupled to each of the further N switches.

21. The wireless communication system of claim 1 wherein the N wireless front end units are radio front end units.

22. The wireless communication system of claim 21 wherein the radio front end units are one of Bluetooth front end units, IEEE 802.11a front end units, IEEE 802.11b front end units and GSM front end units.

23. The wireless communication system of claim 1 wherein said switching arrangement includes a controller for assigning each of the N wireless front end units to a respective one of the N antennae.

24. The wireless communication system of claim 1 wherein said switching arrangement includes at least one single-pole switch connected between each of said wireless front end units and each of said antennae.

25. The wireless communication system of claim 24 wherein said switching arrangement includes a plurality of single pole switches connected between one of said wireless front end units and one of said antennae.

26. A method for sharing N antennae among N wireless front end units, the method comprising:
switching any one of the wireless front end units into connection with any one of the antennae; and
simultaneously maintaining the remaining wireless front end units connected to respective ones of the remaining antennae.

27. The method of claim 26 including synchronously switching N switches having N contacts each.

28. The method of claim 26 including synchronously switching 2N switches having N contacts each.
